(19) United States
(12) Patent Application Publication
(10) Pub. No.: US 2014/0258843 A1
(43) Pub. Date: Sep. 11, 2014

(54) METHOD AND SYSTEM FOR INTER-WIDGET COMMUNICATION

(71) Applicant: Minds and Machines, LLC, Santa Monica, CA (US)

(72) Inventor: Frederick R. Krueger, Santa Monica, CA (US)

(73) Assignee: Minds and Machines, LLC, Santa Monica, CA (US)

(21) Appl. No.: 14/203,537

(22) Filed: Mar. 10, 2014

Related U.S. Application Data
(60) Provisional application No. 61/776,139, filed on Mar. 11, 2013.

(51) Int. Cl. G06F 17/22

(52) U.S. Cl. CPC G06F 17/2247
USPC 715/234

(57) ABSTRACT

The claimed subject matter provides a system and/or a method for building interactive websites and ecommerce stores with datasets and widgets, where the widgets communicate with each other and datasets across different pages on the site. Widgets can have dataset/fields as sources, can set fields of other datasets to their selected values, and can communicate with other widgets on the same page, providing a multimedia experience.

### STATEMENT OF RELATED APPLICATIONS

The present application claims the benefit of copending U.S. Provisional Patent Application No. 61/776,139, filed on Mar. 11, 2013.

### SUMMARY OF THE INVENTION WITH BACKGROUND INFORMATION

The present invention relates to the generation of web pages for display on a computer screen.

In 1989, Tim Berners-Lee, a researcher at CERN, wrote a memo proposing an Internet based Hypertext system called HTML. This led to the beginning of the World Wide Web, which initially consisted of static web pages, linked together by HTML links.

Soon, in the early 1990's various scripting languages took hold, allowing website authors to integrate application programing into their websites. For example, a user could select one of many items on a grid, and the selected item would appear in the user's shopping cart. Or, as another example, a user could select “shoes” from a drop down menu, and a grid of items could be filtered to only show shoes.

Up until about 2006, the only way to implement any such form of user-interaction in a website was to specify the precise behavior in a low level language such as Javascript, PHP, Python, or Perl or some combination thereof. Complex meta-languages such as Drupal, Vignette StoryServer, and Magento emerged to help this task, but still required considerable programming effort on the part of the website owner.

In parallel with the development of web application scripting technologies, various WYSIWIG (What You See Is What You Get) visual website builders were developed, including Microsoft Front Page, Adobe Page Mill, Adobe GoLive, Macromedia Dreamweaver and NetObjects Fusion. This first generation of website builders was not hosted—the website was developed offline and then uploaded to a hosted environment. No implementation of scripting was considered; scripting, if it was even possible, required external code files.

Eventually, around 2005, the advent of technologies such as AJAX (Asynchronous Javascript and XML) allowed for the creation of fully hosted website builders. Such tools include Weebly, Wix, Moonfruit, and SquareSpace. This generation of tools is differentiated from the previous generation in that there is no desktop application—the entire website building process is itself hosted on the web, and runs in a browser window.

It is important to note however, that the current generation of hosted website builders does not include the ability to fully define advanced user interaction of the type mentioned earlier. Beyond simple blogs and image galleries, these tools do not have any means of defining complex applications such as ecommerce sites, photo galleries with multiple views of the underlying data, and review sites such as a wine rating site with custom fields.

Prior art patents and patent applications related to the field of webpage creation include the following: U.S. Pat. No. 5,680,619 for Hierarchical encapsulation of instantiated objects in a multimedia authoring system; U.S. Pat. No. 6,308,188 for System and method for building a web site with automated workflow; U.S. Pat. No. 6,466,210 for Blending image data using layers; U.S. Pat. No. 7,716,629 for System and method for generating web sites in an arbitrary object framework; US Patent application 200500289466 for Multimedia authoring method and system using bi-level theme templates; U.S. Pat. No. 7,979,790 for Combining and displaying multimedia content and US Patent Application 20120272140 for Flexible web page template building system and method.

The present inventive system and method relates to the generation of webpages for display on a computer screen. More particularly, the present inventive system and method relates to the design and user definition of data-driven controls on a web page, online photo gallery or e-commerce site. For ease of reference, any one of a hosted website, an online photo gallery, or an online store will be referred to herein as a “website”. However, it should be understood that the term “website” may refer to any one of a hosted website, an online photo gallery, or an online store.

Traditionally, data-driven websites are implemented in a number of interpreted programming languages such as Perl, PHP or Python. One or more sets of program files written in these languages define the interaction between the user, the website, and a database containing images, text and other file elements. Editing these types of files is a difficult proposition for average users—indeed, a specialized knowledge of programming languages, as well as Hypertext Markup Languages (HTML) is required.

The present inventive system and method describes a way that programming languages may be avoided altogether using a concept of “smart widgets” which talk to easily defined “datasets” and to each other. For example, in present invention a user may define a grid widget by simply dragging a widget inside of a website editor, and then associating that grid with a second page, a dataset, and a field. This construction allows communication between two separate widgets, on two potentially separate pages of the users website.

This general approach is not currently in use in any visual website editing tool and results in significant productivity and time savings versus historical methods.

### BRIEF DESCRIPTION OF THE DRAWINGS

FIG. 1 illustrates a block diagram of an exemplary dataset with user defined fields. Note that the fields may have data-types (text, image, boolean, date etc.), although in the most basic case the fields are simply text fields.

FIG. 2 illustrates a block diagram of a specific web page in the website editor comprised of rectangular regions, widgets moveable within these regions, and a properties palette that allows the specification of widget properties.

FIG. 3. illustrates a block diagram of how a specific widget responds to an event, such as a click, hover or swipe, and either updates the page it is on, or navigates to another page, possibly filtering the different datasets in the site.

FIG. 4 illustrates a block diagram of an exemplary properties palette of a static image widget that, when clicked, navigates to an external web page.

FIG. 5 illustrates a block diagram of an exemplary properties palette of a dynamic image widget that, when clicked, navigates to a lightbox image of the image zoomed in.

FIG. 6 illustrates a block diagram of an exemplary properties palette of a grid widget, that, when clicked, navigates to a specific product detail page, where the ID of the item on the product detail page matches the ID of the grid item in the dataset associated with the grid item.

FIG. 7 illustrates a block diagram of an exemplary properties palette of a grid widget, that, when clicked causes another page to load, with another grid, where the second grid is filtered depending on which item is clicked in the prior grid.

FIG. 8 illustrates an exemplary networking environment, wherein the novel aspects of the claimed subject matter can be employed.

FIG. 9 illustrates an exemplary operating environment that can be employed in accordance with the claimed subject matter.

### DETAILED DESCRIPTION

Referring now to the drawings in general, the illustrations are for the purpose of describing a preferred embodiment of the invention and are not intended to limit the invention thereto.

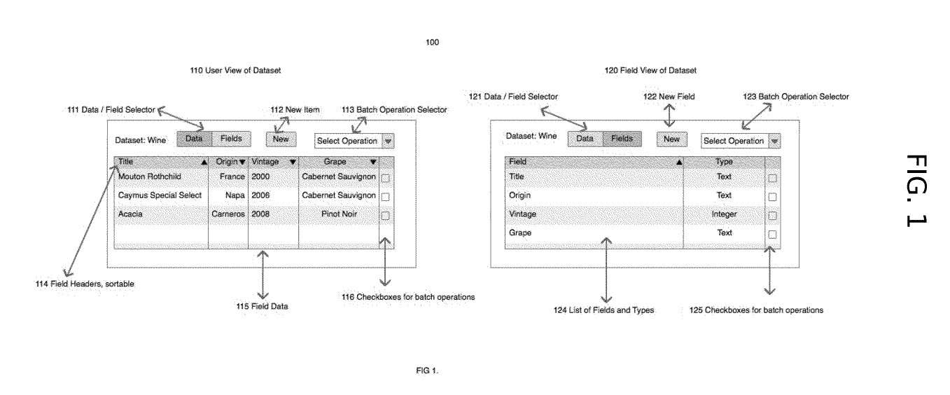

FIG. 1 is a schematic block diagram of a system 100 that allows a user to create and modify a dataset with user-defined fields. The system comprises two separate views, sub-system 110 which is the Data View of the dataset and sub-system 120, the Field View of the dataset. In one embodiment of the system, a selector 111/121 allows the user to switch between the two views, but this selector may be implemented in many different ways including tabs, a button bar, a vertical or horizontal menu or other means. In the Data View (120), the Field names are shown on one axis, which in the preferred implementation is the horizontal axis, and one row of data is provided for each item in the dataset. Readers skilled in the art will recognize that a dataset as described herein is similar to a table in a relational database.

The Field View (120) of the dataset is a view allowing the user to view, add and edit the various fields in each dataset. Note that these fields can vary from dataset to dataset. For example a “cars” dataset might contain fields such as “make”, “model” or “year” while a “staff” dataset might contain fields such as “first name” “last name” and “title”. We note that while different types of database tables are implicitly used in advanced web sites that are coded in such languages as PHP or Python, we are unaware of the integration of the concept of variable field names in a purely visual website editor such as the one described herein. Alternatively or additionally, each record can include tags.

Note that a website may contain several datasets, corresponding to the various types of data in the website. For example, an ecommerce site might contain one dataset for the various items for sale on the site, with fields such as color, size and price, and another one for different press releases, with fields such as heading, subheading, etc, and a dataset for the management team, with fields such as first name, last name and title. General datasets containing text items can also be used for legal notices, such as the privacy policy, terms and conditions, and so on. Keeping this information in datasets as opposed to hard-coded in the website itself or in static “text widgets” makes it easier to edit. This is an advanced form of “Content Management System” or CMS, where the content is separated (in datasets) from the visual look and feel of the website.

Datasets contain data items, or “posts”—which internal to the system can be either in a “selected” or “unselected” state. The set of all selected items is thus a subset of all the dataset items, and represents a filter of a Dataset on a specific page. For example, a page might contain a grid attached to a “cars” database—but depending on how that page is loaded, or what user action occurs on the page, only a subset of this cars database is visible—for example only red cars, or cars made between 1980 and 1989. As we will see below, the core element of this widget communication system is for individual widgets to cause changes in the “selection” of various datasets on various pages in the website.

Having defined the notion of a dataset and a method for users to modify the fields of a dataset, we turn to the description of the website itself as a series of pages, each containing widgets that interact with zero, one or many datasets.

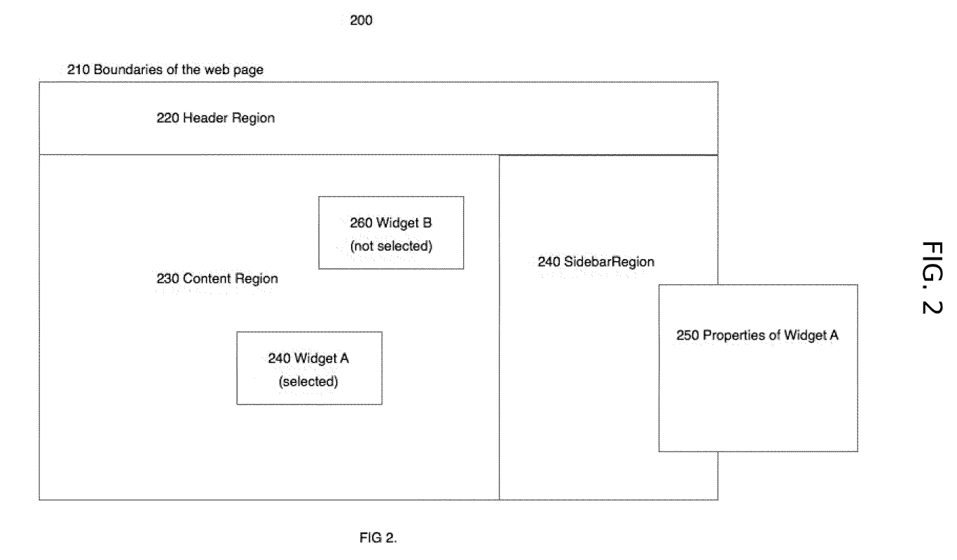

FIG. 2. Is a schematic block diagram of a system 200 that allows a user to move widgets around on a web page. In general, a website comprises a number of webpages that may be ordered in a hierarchical fashion, but in the present system each page is created and edited independently. In 200, the webpage boundary is defined by a rectangle 210. The width of this rectangle may define the active area of the website, with a solid color or image outside the area filling the width of the user's web browser, or, the width may adjust dynamically with the user's browser and all elements within the rectangle re-scaled to fit the actual width viewable by the end-user.

Inside the rectangle 210, we note that the available space is subdivided into several non-overlapping regions, such as the header region 220, the content region 230 and the sidebar region 240. Other regions can be added, such as footer region common in many web pages, and not shown here. Regions can also be further subdivided into rows and columns to create an arbitrary grid structure with varying cell sizes for the page.

Inside each of these regions moveable objects called “widgets” are used to replicate certain looks and behaviors on a web page. For example an “image widget” could be used to depict a single, static image on a page. A “text widget” might contain a paragraph of text. A “video widget” might contain a specific video which can be played within a small area of the website. These widgets are all re-arrangeable within the editor, but generally not in the published website. The way that they can be moved may depend on the type of region they are placed in. For example, a region may be set to “free form” mode, in which case the widgets can be moved on top of each, in the same way layers can be positioned in an image editing program. Or, if the region is set to a “stack” mode, the widgets can only be moved up and down in the stack, with no overlap.

Each widget is represented in the editor in the way it will appear to the end user, in other words “WYSIWIG” (“What You See Is What You Get”). However, we note that the actual content of a widget may be changed dynamically, at run time, so that while the editor can give the general appearance of the web page, the specific widget content may depend on how that page is reached through the browser. For example, a grid widget may show the first 10 items of a dataset in it—for example, the first 10 cars in a car dataset. However, as a result of user filtering, the actual images shown in the grid may be different, containing, for example only the images for red cars.

Widgets can be moved in the website editor by clicking and dragging them. When a widget is clicked (or in some implementations double clicked) it becomes “selected”. In the preferred embodiment of the invention, several widgets may be selected at once, using a combination of input keys. If a single widget is selected, a properties palette 250 contains a list of controls allowing the user to specify the appearance and behavior of the widget. This properties palette may be floating (which is the preferred embodiment), in a fixed position, or appear as a “modal palette”, requiring the user to confirm changes to the widget properties before doing other editing tasks.

The properties palette in general is used to configure the selected widget, but if no widget is selected, it can also be used to modify the properties of a region, for example the header background color. One means of navigating to the region properties is to use a breadcrumb navigation system. In this example, the properties palette 250 for Widget A 240 is shown. It is also shown that Widget A is placed in the Content Region 230, and by clicking on this link the properties for the Content Region can be shown to the user, and that region's properties modified. Note that if several widgets are selected, the property palette may either show nothing (or the parent region), or, in one embodiment, all properties which are common to all selected widgets. For example, one could select two widgets, and use the properties palette to modify, in one operation, the border color for both widgets.

The properties palette is also where a connection is made between widgets and datasets. In general a widget will have a single dataset associated with it, but in other embodiments several datasets can be associated with a single widget. An example of a widget with an attached dataset would be a grid widget attached to the dataset “cars”. In this case, the grid widget would should the images of all the cars in the dataset. The same widget could be attached instead to the dataset “flowers” and would then show images of flowers. Note that even basic media widgets such as an image widget or a text widget can be attached to a dataset, and to a specific field in that dataset, with an initialization value. For example, instead of showing a static image from a library, an image widget could draw its source from a “landscapes” dataset and the field “picture” within that dataset. The widget would initially be set at some specific item within that dataset (typically the first or last entry in the dataset), but then could show a different item depending on the overall selection of that dataset. Similarly a text widget could also draw its source from the “landscapes” dataset, and the field “title” within that dataset.

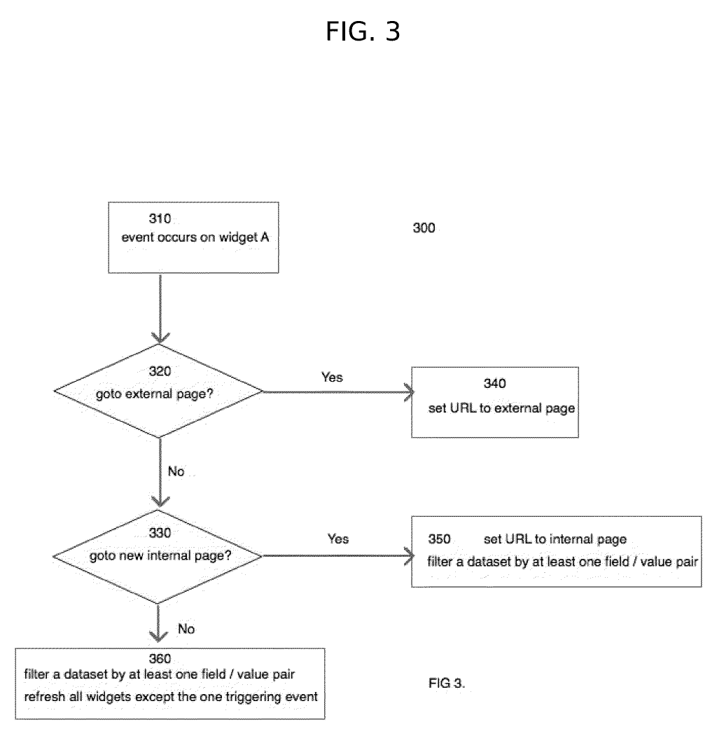

FIG. 3 is a schematic block diagram of a system 300 illustrating an exemplary flow chart specifying the event handling between widgets on a web site.

Since the advent of personal computers, human computer interaction has been studied and defined around the concept of mouse, keyboard and gesture events that occur when a human interacts with a computer. In a widgeting system such as the one described herein, these events occur within the logical boundaries of the widgets. For example, common events occur in this system when a user clicks on a widget (“click event”), mouses over a widget without clicking (“hover event”), types into a text field (“type event”) and specifically, when the user hits return (“return event”). Other events including swiping on a tablet (“swipe event”).

The properties palette of the widget (FIG. 2, 250) is where this event handling is set up. For each type of event recognized by the widget, an action is specified. In the present system, that action is either:

A) loading of an external webpage (external link) or

B) loading or refreshing of an internal page, and specifying a selection set of items on various datasets on that page

In 310, we consider the case where an event occurs. For example, this could be a click event, caused by a user clicking on a specific widget. In this instance, the properties palette is configured to make an appropriate action.

In the case of an external page link (340), a static web address is fetched, and a link to that website is placed in the published HTML, so that clicking on the widget causes the browser to load that external page.

In the case of a new internal page link (350), a link is placed to another page within the website being edited, and a dataset and field combination is passed to the new page. For example, the new page might be mywebsite.com/inventory/dataset=cars&color=red which would cause the new page to only load those red cars. Or, the new page might be mywebsite.com/detail/dataset=cars&id=987 which would load a detail page showing the car with ID 987.

Practitioners skilled in the art will note that passing arguments between webpages in this fashion is a standard way of communicating between webpages. Other ways of passing data are in invisible forms (not in the URL), or in session variables. However, in the figures and discussion below, we will use argument passing in the URL for illustrative purposes.

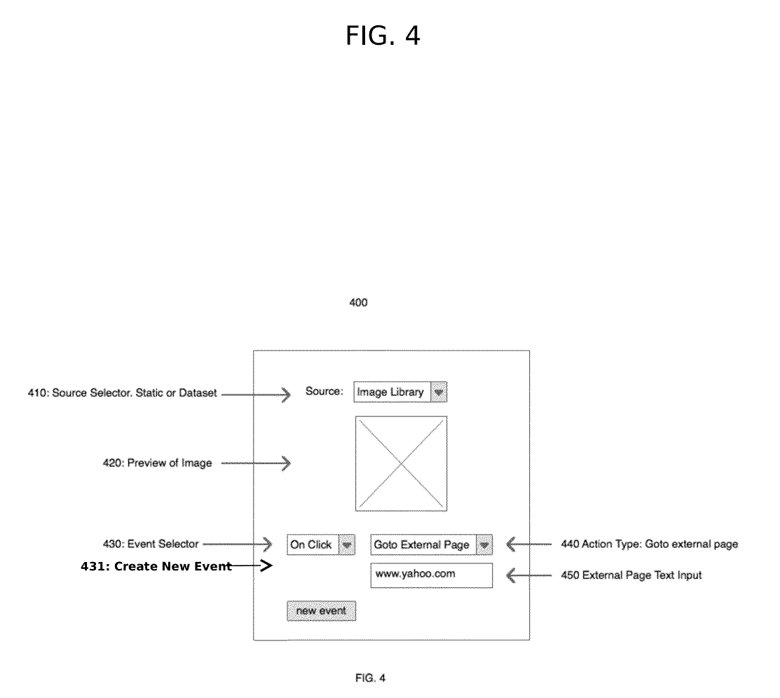

FIG.4 is a schematic block diagram of a properties palette that can be used to set a specific action when an event occurs on a given widget. For illustrative purposes, we chose an image widget, but a similar properties palette could be constructed for any other widget type. In this case, 410 is a source selection that can either be set to a static image library (where the user can upload image assets to the site), or to a dynamically set image, which is stored in a particular item in a field of a dataset.

420 represents a preview of the image being displayed. In the case of a static element, this is just a representation of the media element in a rectangle—in the case of a dynamic element, the first or last (or some specified item) in the dataset, corresponding to a given field is listed (see below).

430 represents an event selector. As mentioned above the system can accommodate a wide variety of events such as a click, a hover event, or a swipe. In the illustration, an event handler for a click on the widget is defined.

440 represents the action selector. For a specific event (in this case a click) an action is performed. In this illustration, the action is to go to an external page specified in text input 450—in other words create a link to the web page www.yahoo.com.

Note that several events can be created for the same widget. For example, we could allow for swiping of the widget by selecting the new event button 431, which creates a new event handler—and defining a new action for the swipe event.

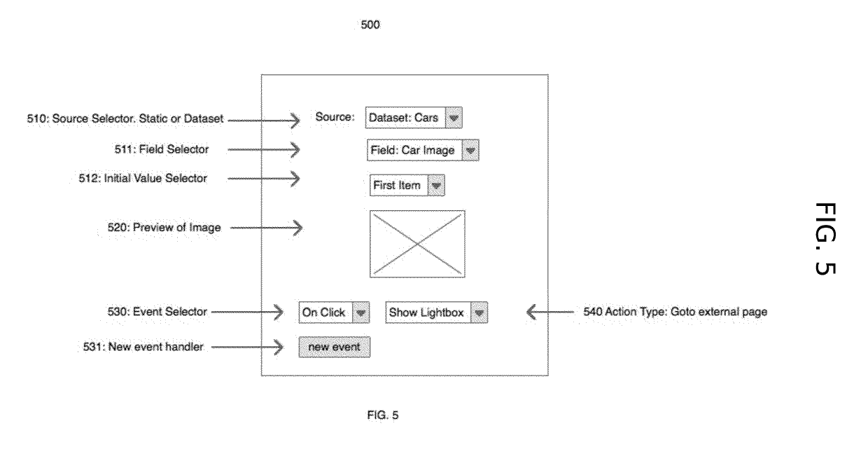

FIG. 5. Represents a more complex, data driven widget—one where the data is not coming from a static source but instead is linked to a specific dataset defined in the dataset picker 510, and the field picker 511. Note that many items may be in the specific dataset addressed by 510—an initial value is required in order to display an image. This value is set in the initial value control 512. A null initial value may be used to not show the widget at all, initially, and only show it if another widget causes the selected subset of the dataset to be non-null.

Note that by selecting a dataset in 510, the field and initial value controls are shown immediately, pushing down the action controls and other controls that we saw in FIG. 4.

In this illustration, the image control causes a zoomed up, full detail image in a lightbox. This action behavior is defined by the dropdown 540. Note that in this particular example, no other arguments are needed. This lightbox user interaction is very common in photography sites, where a grid of photos is presented, and the user clicks to see a lightboxed version (with next and previous arrows) in higher resolution.

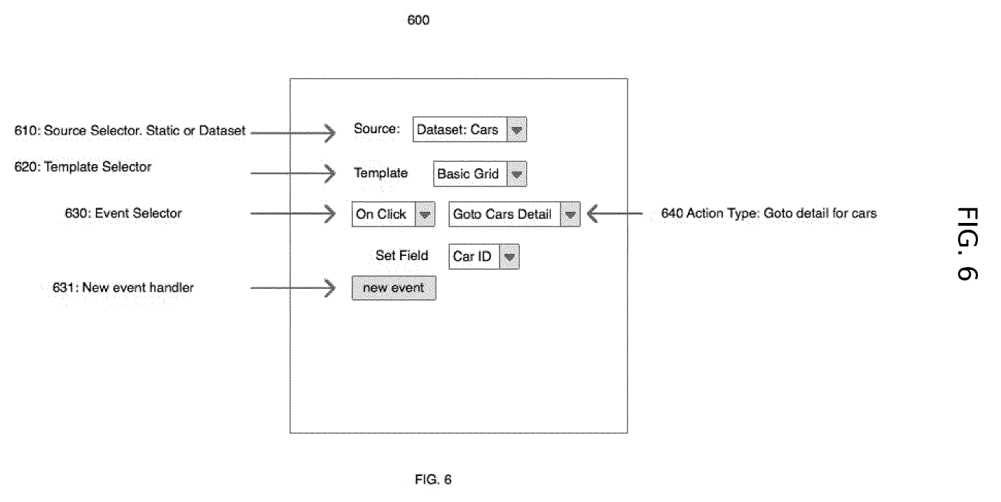

FIG. 6. Represents a further degree of complexity. In this case we have a widget that also is attached to dataset, but, unlike the previous example is capable of displaying multiple items within that dataset. In the example, we are dealing with a grid widget, associated via the dropdown 510 with the dataset “cars”. Depending on the complexity of the grid widget an external template 620 may be required to specify the appearance of the widget.

For this particular widget, a click on a specific item in the grid will cause navigation to a specific detail page set in 640. That detail page will itself contain a control similar to the image widget defined in FIG. 5, drawing its data from the same dataset as the grid that sent it there. In this case, the field ID defining the ID of the item to show in the detail page is set by matching the field ID from the grid. This type of user interaction is very common in ecommerce sites, where a product grid is shown on one page, and the user clicks on the grid to view a detailed page on the item, with the possibility of adding the item to a shopping cart.

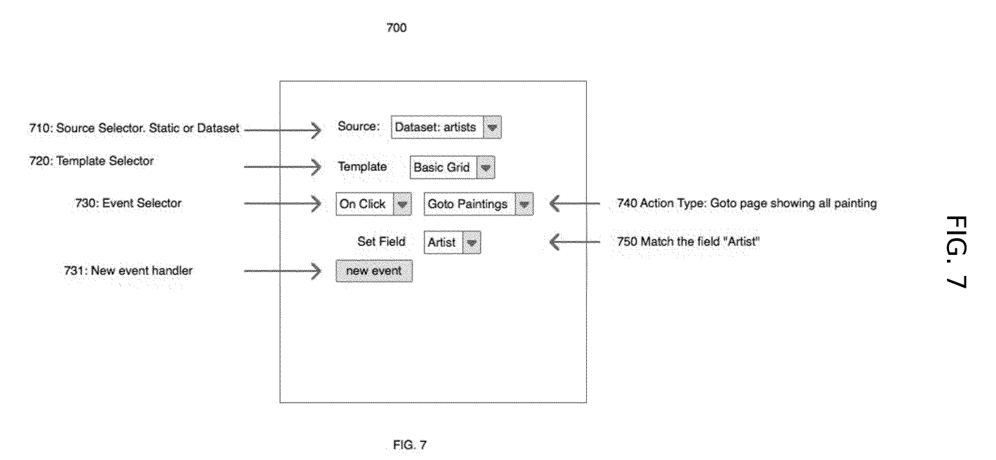

FIG. 7 shows a further degree of complexity. As in FIG. 6, the eventing widget is a grid widget, tied to a specific dataset, in this case a dataset of artists 710. When the user clicks on one of the grid items (a specific artist), the navigation is re-directed to a separate page called “Paintings”, with a dataset also called “Paintings”. Both datasets “artists” and “paintings” contain a field called “artist” which is set in 750 when the user clicks on a picture of an individual artist. By filtering the dataset “Paintings” to match only the artist specified in 700, we can then show a grid of all paintings by that artist. Further clicks on the “Paintings” page might show details of the individual painting on that page, or a separate page, depending on the construction. This type of interaction is quite common on more complex ecommerce sites, where the user first selects a category (by possibly clicking on a grid) and then chooses an item within that category. It also is common for art galleries, photo sites and other sites with large libraries of content.

We note that other possibilities of widget/dataset interaction are possible, but not shown here. In particular, a static image can be made to link to a specific product detail page (a variant of FIG. 6) by matching the detail page by a specific field, for example the product name or ID. This is common in ecommerce sites where on the home page, certain products are “highlighted” and given more screen real estate.

We also note that the target page could be in fact the same as the eventing page. An example of this might be a grid widget, which refreshes a dataset selection, and the selected item's picture and description are shown on the same page, next to the grid. This type of “multimedia” behavior was common in tools such as Adobe Flash and Macromedia Director, but required prior to this invention complex scripting and or coding in order to accomplish.

Thus, the present invention provides a WYSIWYG website authoring system, the system including at least one widget-based page template and at least one database. The at least one page template includes at least one region, the at least one region having the possibility of being different modes, including self-organizing mode and freeform mode. The at least one database is selected from the group consisting of widget databases and content databases. The widget databases include widgets for the presentation of text and/or images, widgets for organization of data, including grid and stack widgets, master widgets for controlling slave widgets and combinations thereof. The present invention further provides for using Javascript libraries, such as JQuery and the like, as sources of widgets.

The content databases are selected from the group consisting of text databases, image databases, Boolean databases, date databases and the like.

A website created with the present invention includes webpages with regions, widgets and data imported by the widgets from databases. The widgets may include master and slave widgets. Thus, the present invention provides for a simple system and methods for the generation of a website.

In another embodiment, the databases and webpage code are hosted on a network in synchronized storage. In this configuration, database and webpage files can be edited offline and the website will update when the user reconnects with the network and the files synchronize. Because the website is widget-based, the edits will automatically be handled by the widgets and these will automatically change the presentation of the data.

The present invention further provides for a web application authoring system and method. The web application authoring system according to the present invention includes the same components as the website authoring system, but further include widgets that provide for input transformation by means other than data presentation. These application widgets provide for the transformation of inputs and data to create outputs that differ from the inputs.

Example application widgets include those containing simple formulas for the transformation of a single input and of multiple inputs. An example is a widget for transforming a temperature from Fahrenheit to Centigrade and vice-versa. More complicated widgets include multiple inputs, as in spreadsheet widgets. Other widgets can provide for the tranformation of the visual qualities of an input. For example, transforming of color photographs into black-and-white photographs.

An example of such a web application is one wherein a mortgage lender has created a webpage to provide a means to user to calculate a mortgage payment. The user inputs the loan amount, interest rate, loan term and the widget calculates the monthly payment. Thus, the creation of web applications is facilitated by the present invention.

Users can access a library of widgets to create a web application, such as providing a service over the web. The web application can be public or private. The present system allows user to quickly design their own applications using already existing widgets. In certain cases a custom widget may be needed and will need to be coded ad hoc. Regardless, the present invention will nonetheless reduce the cost and time-to-implementation of web applications because only the custom widgets need to be coded. Thus, the present invention modularizes the design and creation of web applications. The application widgets can be made to communicate between themselves in a variety of manners, including through manual connection by the developer or through automatic widget intercommunication.

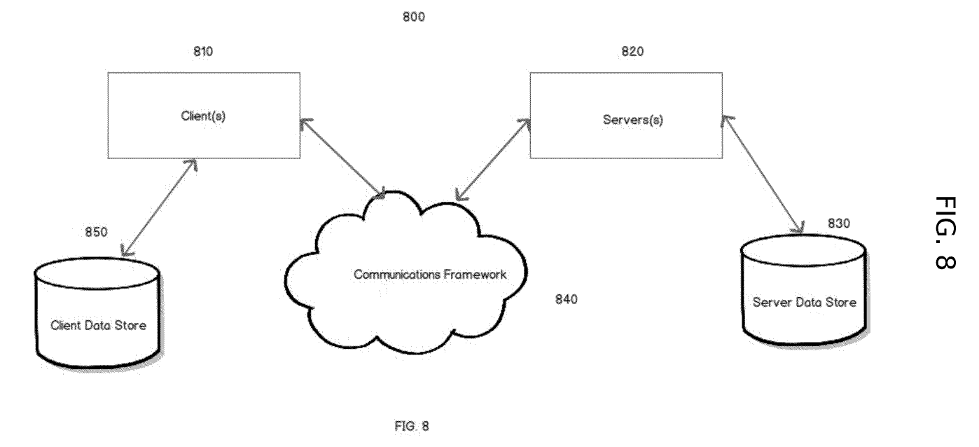

FIG. 8 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

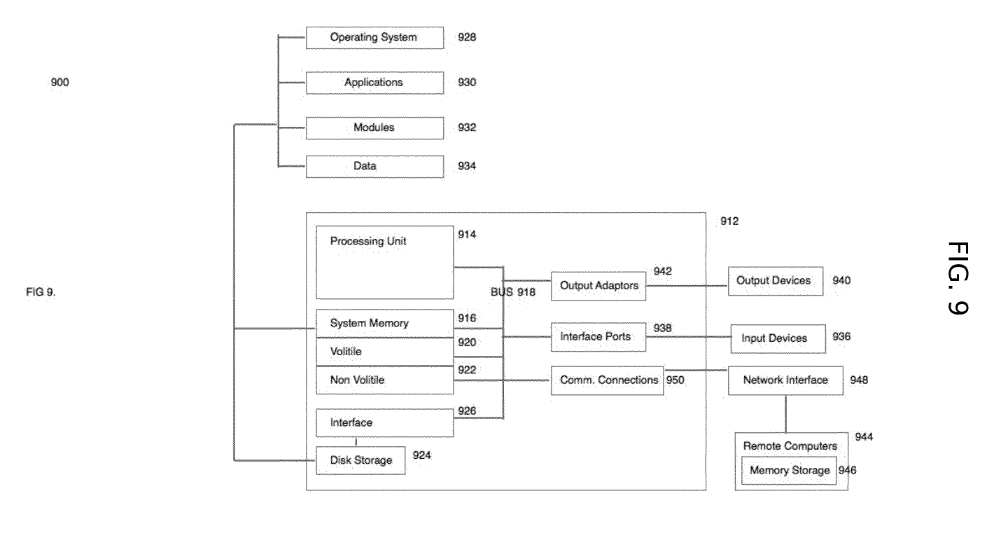

With reference to FIG. 9, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as modems, including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layer, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates the creation of interactive web pages on the Internet, comprising:
a set of user defined datasets each with customized fields;
a set of widgets that can be placed on a web page and that draw their data from the datasets; and
a set of triggering rules,
wherein a click or other event on a widget causes a refresh of a “target page” and a filter action of one or more of the datasets on the target page.

2. The system of claim 1, wherein the target page is the same as the web page in which the targeting widget resides, in which case other widgets affected by the filtering action (with the exception of the source widget) are refreshed.

3. The system of claim 1, wherein the target page is shown as a lightbox overlay on top of the source page, and corresponds to a single dataset item.

4. The system of claim 1, wherein the target page is a new page containing multiple items from a dataset, and the new page is shown with a set of filters that is determined by the event on the source page.

5. The system of claim 1, wherein the target page is a new page that represents a single dataset item corresponding to the the source dataset event action.

6. The system of claim 3, wherein the result of the filtering is a dataset containing more than one item, and the first, or last element of the dataset is shown in the lightbox.

7. The system of claim 5, wherein the result of the filtering is a dataset containing more than one item, and the first of last element of the dataset is shown in the lightbox.

8. The system of claim 6, wherein a mechanism (such as either clicking on a specific button or an image) cycles through the dataset entries either starting with the first item in the result dataset in ascending order, or starting with the last element in descending order.

9. The system of claim 7, wherein a mechanism (such as either clicking on a specific button or an image) cycles through the dataset entries either starting with the first item in the result dataset in ascending order, or starting with the last element in descending order.

10. The system of claim 1, whereupon multiple fields of a dataset are filtered on a given event.

11. The system of claim 1, wherein one of the widgets is a filter which applies to the target dataset on a page load event from another widget; and further wherein when a button is clicked, a grid is generated on a target page, and a price range slider is used to filter the resulting dataset.

12. A method that facilitates creation of interactive web pages on the Internet, comprising: associating datasets with widgets in a website or ecommerce application, wherein the source dataset and field are specified in a properties palette.

13. The method recited in claim 12, further comprising associating widgets with user-definable regions that have a specific type which defines how the widget can be moved within the region.

14. The method recited in claim 13, wherein the type is set to “free form”, meaning that the widget can be moved freely in the region, possibly overlapping other widgets.

15. The method recited in claim 13, wherein the type is set to “stack”, meaning that widgets can be moved up and down in the region, like a column or “stack”, and that if one widget grows in height it will push down all the widgets below it on the stack.

16. The method recited in claim 13, further comprising navigating to properties of a region by means of a navigation breadcrumb, thereby editing the properties of a region in the same way as editing the properties of a widget.

17. A system for creating web pages, comprising:
at least one dataset;
at least one widget that can be placed on a web page and that draws data from the at least one dataset; and
at least one triggering rule responding to a triggering event on the at least one widget,
wherein the triggering event on the at least one widget refreshes a target page and filters the at least one dataset on the web page.
